(19) United States
(12) Patent Application Publication
(10) Pub. No.: US 2009/0006252 A1
(43) Pub. Date: Jan. 1, 2009

(54) BILLING DATA REPORT SYSTEM

(75) Inventors: Muhammad Faisal Rehman, San Jose, CA (US); Demika Montjoy, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 11/771,618

(22) Filed: Jun. 29, 2007

(51) Int. Cl. G06Q 40/00

(52) U.S. Cl. 705/40

(57) ABSTRACT

A method and a system directed to a billing data report system are described. For example, a server receives billing data from one or more data sources, generates one or more calculated results using the billing data and using a term from a service level agreement, and transmits one or more calculated results to a client, which receives and displays one or more calculated results.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 1995-2007, eBay, Inc. All Rights Reserved.

### TECHNICAL FIELD

Example embodiments relate generally to the technical field of data processing systems.

### BACKGROUND

The providing of network-related services, such as network services, often involves specific arrangements for billing. In a relationship between a provider and an entity served by the provider, such an arrangement may be set forth in terms of a service level agreement (SLA). Billing arrangements and SLAs may vary among the relationships a provider maintains with multiple entities served by the provider. It is helpful to automate calculation of billing information, as well as to display billing information in an organized manner. An example of a technical challenge that may exist is maintaining a specific organization of billing information after additions to, alterations to, or deletions of billing information.

### BRIEF DESCRIPTION OF THE DRAWINGS

Some embodiments are illustrated by way of example and not limitation in the figures of the accompanying drawings in which:

FIG. 1 is a network diagram illustrating components of an example embodiment;

FIG. 2 is a block diagram illustrating components of an example server;

FIG. 3 is a block diagram illustrating components of an example client;

FIG. 4 is a flow chart illustrating steps of a method according to an example embodiment;

FIG. 5 is a view of a computer screen illustrating an example login page;

FIG. 6 is a view of a computer screen illustrating an example summary report;

FIG. 7 is a view of a computer screen illustrating a portion of an example detailed report;

FIG. 8 is a view of part of a computer screen illustrating a portion of an example of a detailed report;

FIG. 9 is a view of part of a computer screen illustrating a portion of an example update page;

FIG. 10 is a view of part of a computer screen illustrating a portion of an example update page;

FIG. 11 is a view of part of a computer screen illustrating a portion of an example update page;

FIG. 12 is a view of a computer screen illustrating an example history page; and

FIG. 13 is a block diagram illustrating components of an example machine able to read instructions from a machine-readable medium.

### DETAILED DESCRIPTION

Example methods and systems directed to data report generation are described. In the following description, for purposes of explanation, numerous specific details are set forth in order to provide a thorough understanding of example embodiments. It will be evident, however, to one skilled in the art that the present invention may be practiced without these specific details.

A server receives billing data and uses the billing data and a term from a service level agreement to generate one or more calculated results (e.g., billing statistics, billing metrics, etc.). The server may associate an ordinal indicator (e.g., a sorting parameter, or a sorting identification number) with one or more calculated results. A client receives one or more calculated results and displays the calculated results as a billing data report. The client may use an ordinal indicator (e.g., sorting parameter, or sorting identification number) to order the display of the calculated results. Some benefits of the example methods and systems may include: automatic receiving of billing data, display of calculated results as a billing data report; and a specific ordered display of a billing data report.

### Architecture

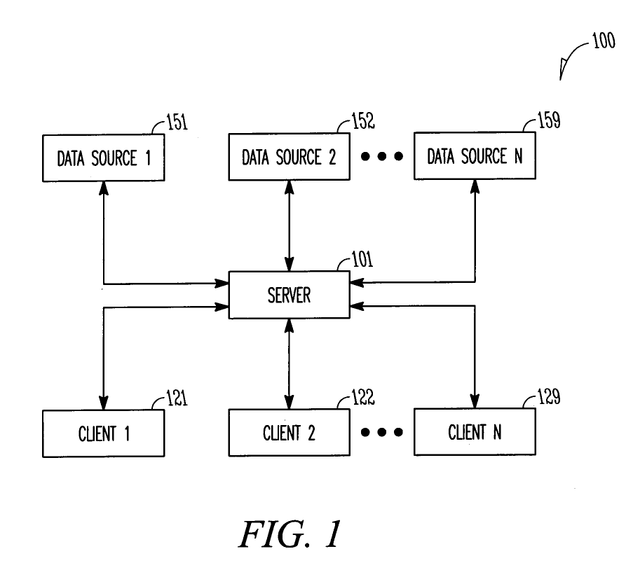

FIG. 1 is a network diagram illustrating a client-server system 100, within which one example embodiment may be deployed. A data source 1 151, a data source 2 152, and a data source N 159 represent one or more data sources. In the example, one or more data sources are in communication with a server 101 via a network (e.g., the Internet, a wide area network, etc.). In certain embodiments, a data source (e.g., data source N 159) may be a database, a client (e.g., client N 129), a data feed, an email server, or a telephone.

A client 1 121, a client 2 122, and a client N 129 represent one or more clients in communication with the server 101. The server 101 provides server-side functionality via a network (e.g., the Internet, a wide area network, etc.) to one or more clients (e.g., client N 129). In certain embodiments, at least one client (e.g., client N 129) is itself a data source (e.g., data source N 159).

In an example deployment, the server 101 is a web server, and at least one client (e.g., client 1 121) is a web client (e.g., a browser, such as the INTERNET EXPLORER browser developed by MICROSOFT CORPORATION of Redmond, Wash. State). In another example, at least one client (e.g., client N 129) is a programmatic client. In another example, the server 101 is a multi-hosted server or a load-balanced server.

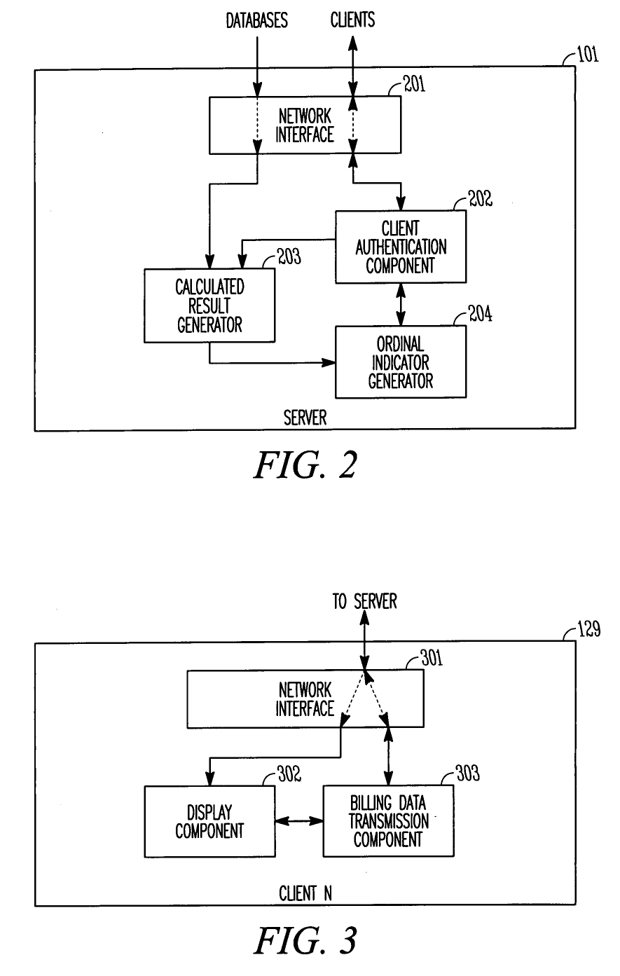

FIG. 2 is a block diagram illustrating an example server 101. A network interface 201 is in communication with a network (e.g., the Internet, a wide area network, etc.). A calculated result generator 203 is in communication with the network interface 201. In some embodiments, billing data from one or more databases is received at the network interface 201 and routed to the calculated result generator 203. A client authentication component 202 is in communication with the network interface 201. In some embodiments, billing data from one or more clients (e.g., client N 129) is received at the network interface 201 and routed to a client authentication component 202. The client authentication component 202 determines whether billing data from one or more clients (e.g., client N 129) is used by the calculated result generator 203.

In an example deployment, a calculated result generator 203 (e.g., processor, calculator, comparator, etc.) is in communication with the network interface 201, the client authentication component 202, and an ordinal indicator generator 204. The calculated result generator 203 generates a calculated result. In certain embodiments, the ordinal indicator generator 204 is in communication with the client authentication component 202 and generates an ordinal indicator (e.g., sorting parameter, sorting identification number, etc.) associated with one or more calculated results. In some examples, the client authentication component 202 determines whether one or more clients (e.g., client N 129) display one or more calculated results.

FIG. 3 is a block diagram illustrating an example client (e.g., client N 129). A network interface 301 is in communication with a network (e.g., the Internet, a wide area network, etc.). In an example deployment, a display component 302 is in communication with the network interface 301 and a billing data transmission component 303. The billing data transmission component 303 may communicate with the network interface 301.

### Flowchart

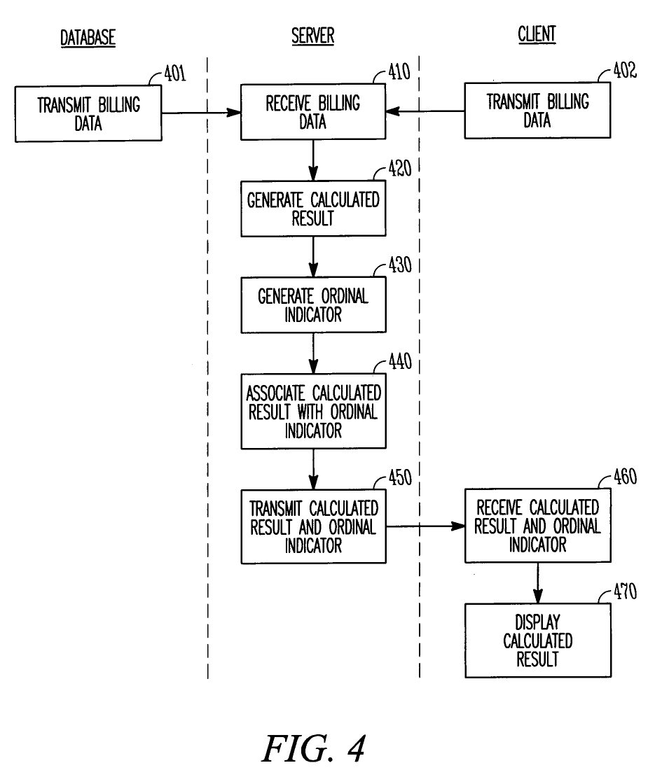

FIG. 4 is a flow chart illustrating a method to process data according to an example embodiment. At operation 401, a database (e.g., data source 1 151) transmits billing data to a server 101. At operation 402, a client (e.g., client N 129) transmits billing data to the server 101.

At operation 410, the server 101 receives billing data from a database (e.g., data source 1 151). The server 101 may receive billing data from a client (e.g., client N 129). In certain embodiments, a client authentication component 202 in the server 101 determines whether to receive billing data from a client (e.g., client N 129) by comparing specific rules to an authentication level associated with the client (e.g., client N 129). In certain embodiments, at operation 410, the server 101 receives billing data from another data source (e.g., data feed, email server, telephone, etc.).

At operation 420, the server 101 generates a calculated result using the billing data and a term from a service level agreement (SLA). The SLA may be a contract, standard, regulation, obligation, promise, custom, habit, or expectation relating to a specified level of service in the providing of network-related services. In generating the calculated result, the server 101 generates a percentage of the term from the SLA. In certain embodiments, the term from the SLA is a number of messages (e.g., messages within a specified period of time, such as messages per day, messages per quarter, etc.). In an example deployment, the messages include a communication related to e-commerce, sales, purchases, financial transactions, credit checks, network performance, service availability, technical support, or customer service (e.g., an email inquiry, a refund request, a sent email, a received fax, a bankruptcy inquiry, a trace ticket, etc.).

At operation 430, the server 101 may generate an ordinal indicator (e.g., sorting parameter, sorting identification number, etc.). At operation 440, the server 101 may associate the ordinal indicator with the calculated result to order the calculated result for display as a billing data report.

At operation 450, in an example deployment, the server 101 transmits the calculated result to a client (e.g., client N 129). The server 101 may transmit an ordinal indicator associated with the calculated result to the client (e.g., client N 129).

At operation 460, in an example embodiment, a client (e.g., client N 129) receives the calculated result from the server 101. The client (e.g. client N 129) may receive an associated ordinal indicator with the calculated result. At operation 470, the client (e.g., client N 129) displays the calculated result, using the ordinal indicators to order the calculated result into a billing data report.

In certain embodiments, the client (e.g., client N 129) displays one or more of the following: a summary report of calculated results; a detailed report of calculated results; an update page to receive billing data and transmit billing data to the server 101; and a history page containing links to display an archived summary report or an archived detailed report stored on the server 101.

### User Interfaces

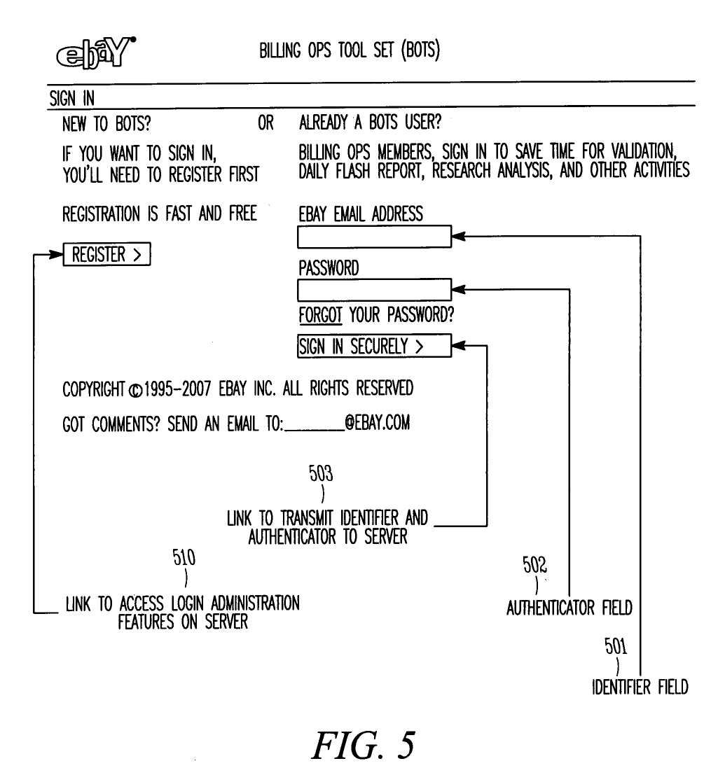

FIG. 5 illustrates an example login page displayed by a client (e.g., client N 129). In certain embodiments, a client authentication component 202 in a server 101 determines whether to receive billing data from one or more clients (e.g. client N 129) by associating each client with an authentication level and comparing the authentication level (e.g., access level) to one or more specific rules (e.g. access permissions).

The client (e.g., client N 129) displays an identifier field 301 to receive an identifier (e.g., email address, username, etc.). The client (e.g., client N 129) displays an authenticator field 302 to receive an authenticator (e.g. password, personal identification number, etc.). The client (e.g., client N 129) displays a link 303 to submit the identifier to the server 101.

The client (e.g., client N 129) displays a link 310, which when clicked on by a user, provides access to login administration features on the server 101 (e.g., new identifier creation, password reset, password reminder, etc.). In some embodiments, a client (e.g., client N 129) displays a control to store the login identifier and authenticator for a specified period of time.

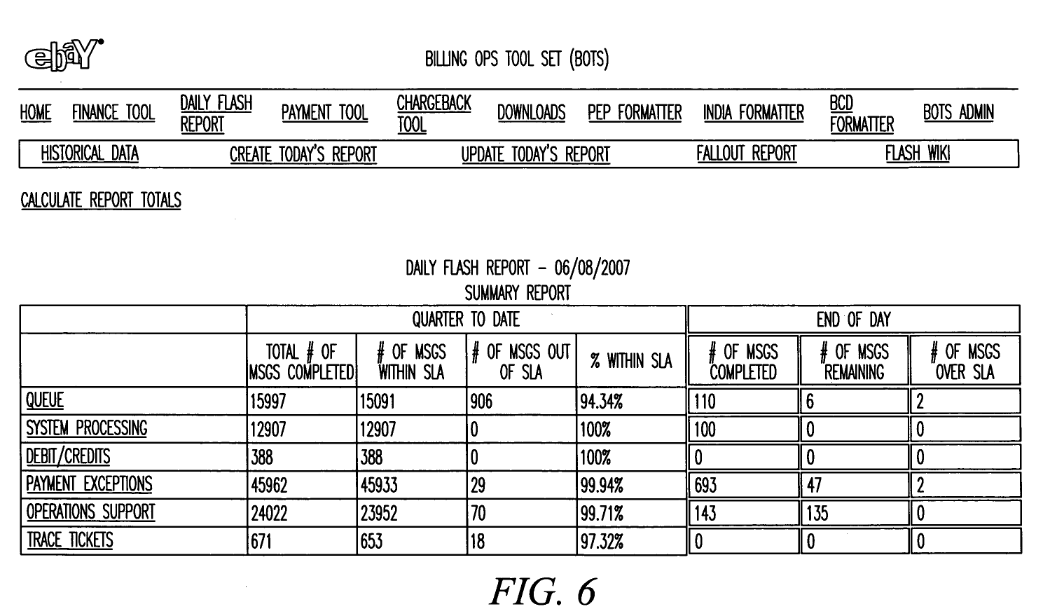

FIG. 6 illustrates an example billing data report displayed by a client (e.g., client N 129) as a summary report. The client (e.g. client N 129) displays a summary report including an aggregate of calculated results associated with a specified period of time (e.g., hour, day, week, month, quarter, year, etc.). The client (e.g., client N 129) displays calculated results organized into one or more specified categories. In the example illustrated, the specified categories are: queue, system processing, debits/credits, payment exceptions, operations support, and trace tickets.

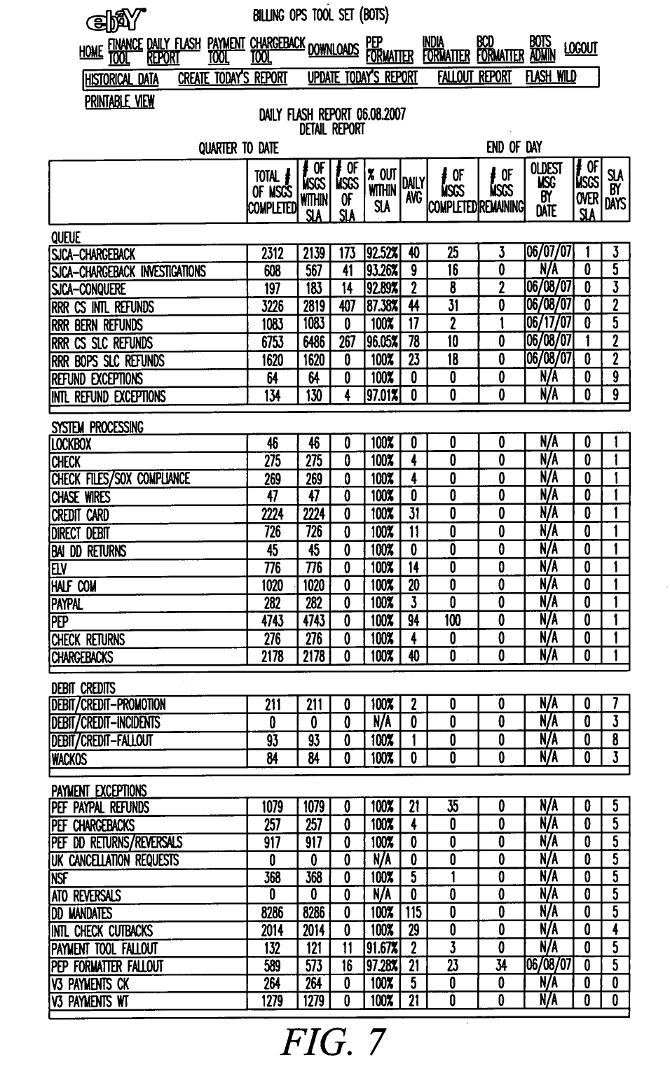

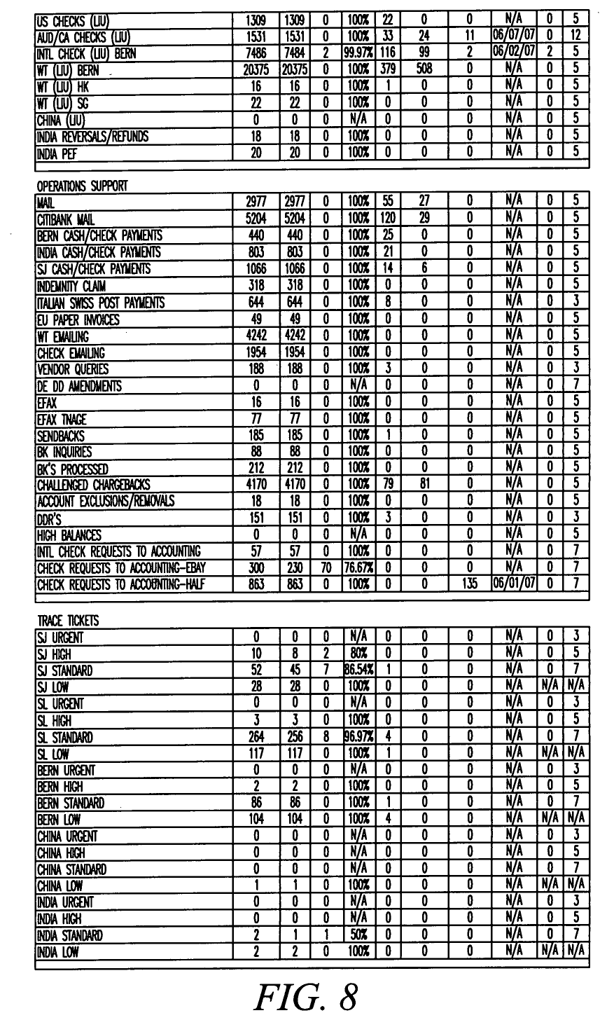

FIGS. 7 and 8 illustrate portions of an example billing data report displayed by a client (e.g., client N 129) as a detailed report. The client (e.g. client N 129) displays a detailed report including an aggregate of calculated results associated with a specified period of time (e.g., hour, day, week, month, quarter, year, etc.). The client (e.g., client N 129) displays calculated results organized into one or more specified categories. In the example illustrated, the specified categories are: queue, system processing, debits/credits, payment exceptions, operations support, and trace tickets. The client (e.g. client N 129) displays calculated results organized into one or more specified sub-categories. In an example embodiment, the specified sub-categories include the following:

| Category | Sub-categories |
|---|---|
| Queue | Chargebacks - Geolocation 1 |
| | Chargebacks - Geolocation 2 |
| | Chargeback Investigations |
| | Chargeback Inquiries |
| | Refund Requests |
| | Refund Exceptions |
| System Processing | Lockbox |
| | Check |
| | Check Files/SOX Compliance |
| | Wire Transfers |
| | Credit Card Transactions |
| | Direct Debit |
| | Internal Payments |
| | Internal Check Returns |
| | Internal Chargebacks |
| Debits/Credits | Debit/Credit-Promotions |
| | Debit/Credit-Incidents |
| Payment Exceptions | Payment Reversal Requests |
| | Payments Posted To User Accounts |
| Operations Support | Mail Processed |
| | Bank Mail Processed |
| | Regular Emails Sent |
| | Emails Received |
| | Vendor Queries |
| | Faxes Received |
| | Faxes Sent |
| | Bankruptcy Inquiries Initiated |
| | Bankruptcy Inquiries Processed |
| | Challenged Chargebacks |
| | Account Exclusions/Removals |
| | High Balances |
| | International Check Requests |
| | to Accounting |
| | Domestic Check Requests to Accounting |
| Trace Tickets | Geolocation 1 - Urgent |
| | Geolocation 1 - High Priority |
| | Geolocation 1 - Standard Priority |
| | Geolocation 1 - Low Priority |
| | Geolocation 2 - Urgent |
| | Geolocation 2 - High Priority |
| | Geolocation 2 - Standard Priority |
| | Geolocation 2 - Low Priority |

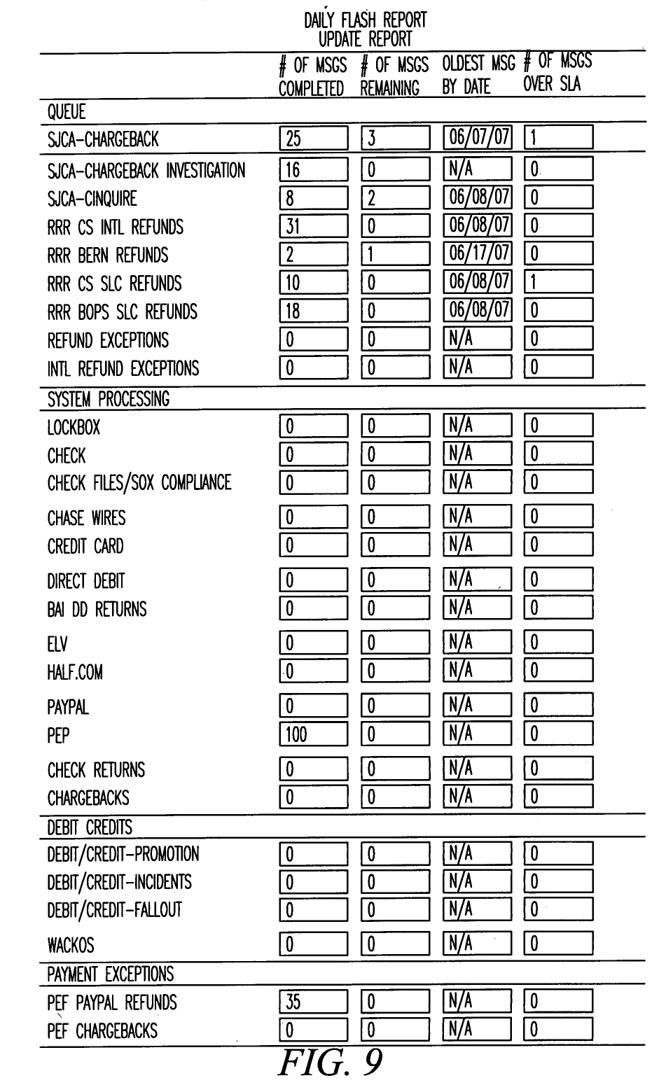

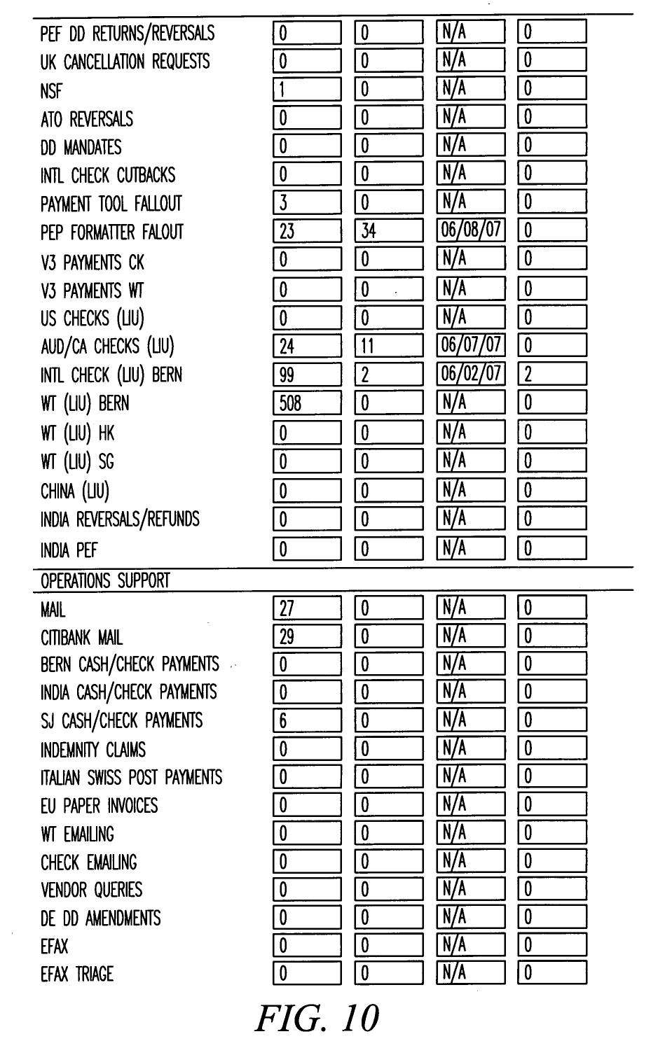

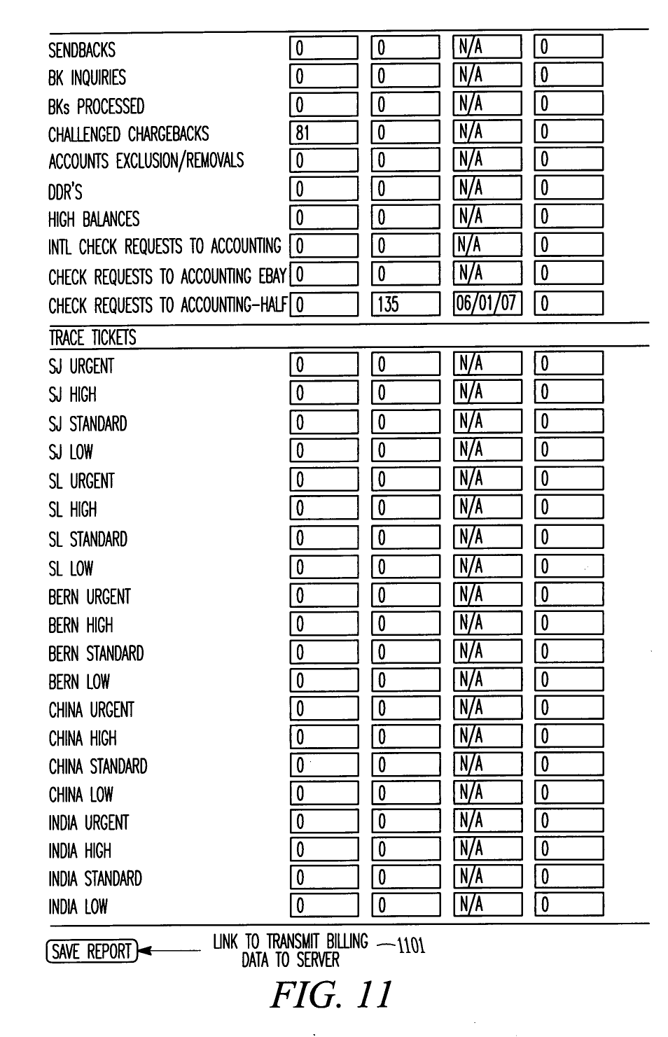

FIGS. 9, 10, and 11 illustrate portions of an example update page displayed by a client (e.g., client N 129). The client (e.g., client N 129) displays an update page to receive billing data and to transmit billing data to a server 101. The client (e.g., client N 129) displays a field to receive billing data associated with a category. The billing data may be associated with a sub-category. In the example illustrated, multiple fields in specified categories and sub-categories receive the following billing data: number of messages completed, number of messages remaining, age of an oldest message as of a specified date, and number of messages exceeding a term from a service level agreement (SLA). The client (e.g., client N 129) may display a link 601 to transmit billing data to the server 101.

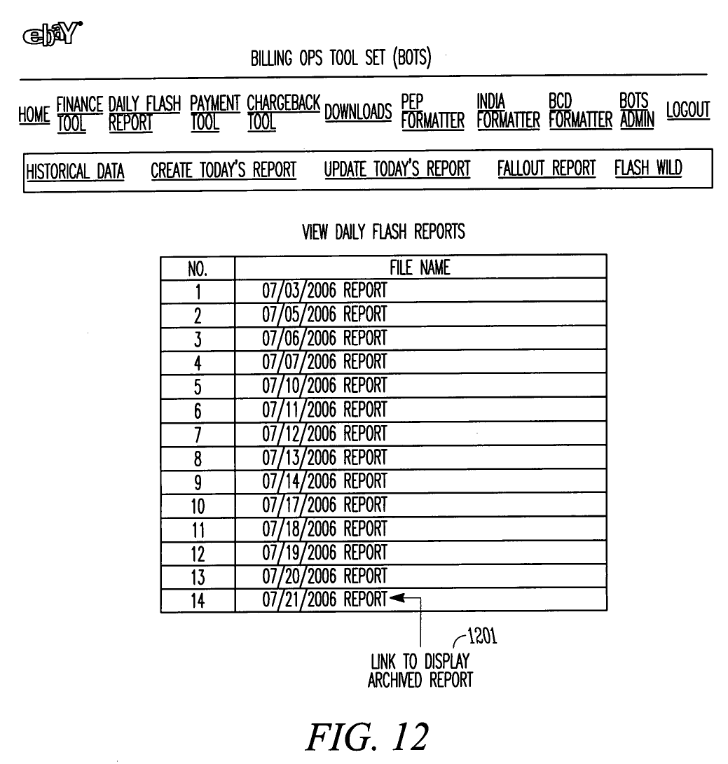

FIG. 12 illustrates an example of a history page displayed by a client (e.g., client N 129). In an example deployment, the server 101 stores one or more billing data reports (e.g., summary reports of calculated results, detailed reports of calculated results, etc.) in an archive. The client (e.g., client N 129) displays one or more links (e.g., link 701) to cause the server 101 to transmit an archived billing data report (e.g. summary report, detailed report, etc.) to the client (e.g., client N 129). The client (e.g., client N 129) displays the archived billing data report (e.g., summary report, detailed report, etc.) received from the server 101. In some embodiments, the client (e.g., client N 129) displays a search field or a link to a search page for searching the server 101 for at least one specific archived billing data report (e.g., summary report, detailed report, etc.).

### Platform Architecture

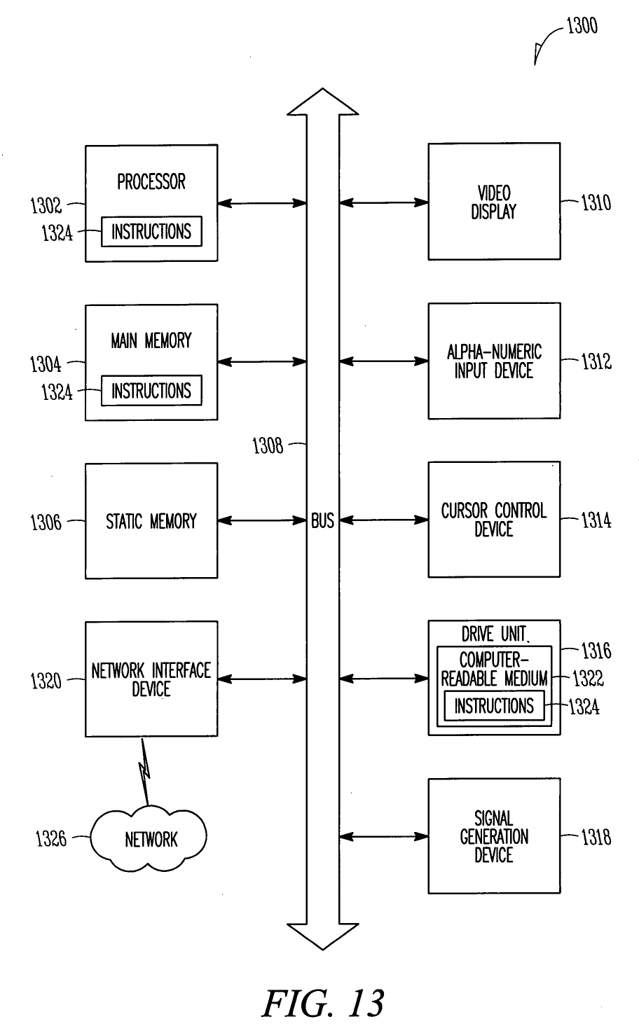

FIG. 13 shows a diagrammatic representation of machine in the example form of a computer system 1300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU) a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a disk drive unit 1316, a signal generation device 1318 (e.g., a speaker) and a network interface device 1320.

The disk drive unit 1316 includes a machine-readable medium 1322 on which is stored one or more sets of instructions (e.g., software 1324) embodying any one or more of the methodologies or functions described herein. The software 1324 may also reside, completely or at least partially, within the main memory 1304 and/or within the processor 1302 during execution thereof by the computer system 1300, the main memory 1304 and the processor 1302 also constituting machine-readable media.

The software 1324 may further be transmitted or received over a network 1326 via the network interface device 1320.

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, methods and systems directed to a billing data report system have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a server module comprising:
a network interface to receive billing data from at least one of a plurality of data sources; and
a result generator to generate a calculated result using the billing data and using a term from a service level agreement, the network interface being to transmit the calculated result.

2. The system of claim 1 further comprising a client module to receive the calculated result from the server module, and to display the calculated result.

3. The system of claim 1 wherein the server module is to receive billing data from at least one of plurality of data sources including a database, a client module, a data feed, an email server, or a telephone.

4. The system of claim 1 wherein the server module, in generating the calculated result, is to generate a percentage of the term from the service level agreement.

5. The system of claim 1 wherein the server module, in using the term from the service level agreement, is to use a number of messages.

6. The system of claim 5 wherein the messages include at least one of an emailed inquiry, a refund request, a sent email, a received fax, a bankruptcy inquiry, or a trace ticket.

7. The system of claim 1 wherein the client module is to display the calculated result using an ordinal indicator associated with the calculated result, the ordinal indicator being to order the displaying of the calculated result.

8. The system of claim 7 wherein the ordinal indicator is at least a sorting parameter, or a sorting identification number.

9. A method comprising:
receiving billing data from at least one of a plurality of data sources; and
generating a calculated result using the billing data and using a term from a service level agreement.

10. The method of claim 9 further comprising transmitting billing data.

11. The method of claim 9 further comprising displaying the calculated result.

12. The method of claim 9 wherein at least one of the plurality of data sources includes a database, a client, a data feed, an email server, or a telephone.

13. The method of claim 9 wherein the calculated result is a percentage of the term from the service level agreement.

14. The method of claim 9 wherein the term from the service level agreement is a number of messages.

15. The method of claim 14 wherein the messages include at least one of an emailed inquiry, a refund request, a sent email, a received fax, a bankruptcy inquiry, or a trace ticket.

16. The method of claim 9 further comprising associating an ordinal indicator with the billing calculation, the ordinal indicator being to order a display of the calculated result.

17. The method of claim 16 wherein the ordinal indicator is at least a sorting parameter, or a sorting identification number.

18. A machine-readable medium comprising instructions, which when implemented by one or more processors, cause the one or more processors to perform the following operations:
receiving billing data from at least one of a plurality of data sources; and
generating a calculated result using the billing data and using a term from a service level agreement.

19. A system comprising:
server means for receiving billing data from at least one of a plurality of data sources, generating a calculated result using the billing data and using a term from a service level agreement, and transmitting the calculated result to a client; and
client means for receiving the calculated result from the server, and displaying the billing calculation.

20. The system of claim 19 wherein at least one of the plurality of data sources includes a database, a client, a data feed, an email server, or a telephone.

21. The system of claim 19 wherein the calculated result is a percentage of the term from the service level agreement.

22. The system of claim 19 wherein the term from the service level agreement is a number of messages.

23. The system of claim 22 wherein the messages include at least one of an emailed inquiry, a refund request, a sent email, a received fax, a bankruptcy inquiry, or a trace ticket.
